(19) United States
(12) Patent Application Publication
(10) Pub. No.: US 2008/0002067 A1
(43) Pub. Date: Jan. 3, 2008

(54) REAR PROJECTION TYPE DISPLAY DEVICE

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/769,786

(22) Filed: Jun. 28, 2007

(30) Foreign Application Priority Data
Jun. 30, 2006 (JP) 2006-180605

(51) Int. Cl. H04N 9/31

(52) U.S. Cl. 348/744; 348/E05.133

(57) ABSTRACT

A projection device is provided with an upright screen on which an image is projected, an image projection unit configured to emit light carrying an image to be projected on the screen, the image projection unit being arranged behind a lower portion of the screen, and a mirror configured to deflect light emitted by the image projection unit toward the screen, the mirror being arranged behind an upper portion of the screen, the mirror having a front edge and a rear edge, the front edge being arranged closer to the screen than the rear edge. The mirror is arrange such that an angle α meets a formula:

$$90 - \frac{38.1 D}{H} \leq α \leq 90 - \frac{27.3 D}{H} ,$$

where, α represents an angle formed between the screen and the mirror, D represents a distance between the screen and the rear edge of the mirror, and H represents a length of the upright screen in the direction of the screen.

### BACKGROUND OF THE INVENTION

The present invention relates to an oblique projection type projection device configured to project a source image on a screen by obliquely projecting light carrying the image to be projected on a screen.

An oblique projection type projection device capable of projecting an image on a screen by obliquely projecting light carrying the image without trapezoidal distortion is well known. The oblique projection device is particularly advantageous for reducing a size of a rear-projection device, which is configured to project an image from a rear side of a screen. The displayed image is viewed on a front side of the screen. Hereinafter, throughout the specification, a term “the projection device” will be used to refer to “the oblique projection type projection device”.

The projection device is generally provided with a projection optical system, at least one mirror, and a screen. The projection optical system is configured to emit light carrying an image to be projected on the screen. The light emitted from the projection optical system is deflected by the at least one mirror and is directed toward the screen. In order to downsize the projection device, for example, the projection device may be configured such that the projection optical system is arranged at a lower position with respect to the screen, and the mirror is arranged on an inner surface of the top panel of the projection device. An example of such a projection device is disclosed in Japanese Patent Provisional Publication No. 2005-43681 (hereinafter, referred to as '681 publication).

In '681 publication, when the mirror is fixed on the top board of the projection device, it is required to adjust an angle of the mirror with respect to the screen. In order to adjust the angle of the mirror, each edge of the mirror in a horizontal direction is formed so that the adjustment of the angle is enabled, and the mirror is fixed on the projection device with these edges.

However, when the mirror is fixed as above, a flexure of the mirror due to its own weight occurs in an orthogonal direction to the screen. Additionally, a various flexure might occur because of the individual difference when the mirror is manufactured. Such flexure of the mirror causes a deterioration of an image quality such as a focal shift, etc.

### SUMMARY OF THE INVENTION

In view of the foregoing drawbacks, the present invention is advantageous in that a projection device capable of reducing its size and preventing a deterioration of an image quality caused by a flexure of a mirror, is provided.

According to an aspect of the invention, there is provided a projection device, which is provided with an upright screen on which an image is projected, an image projection unit configured to emit light carrying an image to be projected on the upright screen, the image projection unit being arranged behind a lower portion of the upright screen, a mirror configured to deflect light emitted by the image projection unit toward the upright screen, the mirror being arranged behind an upper portion of the upright screen, the mirror having a front edge and a rear edge, the front edge being arranged closer to the screen than the rear edge. Such a projection device is configured such that an angle α formed between the mirror and the upright screen meets a formula:

$$90 - \frac{38.1 D}{H} \leq α \leq 90 - \frac{27.3 D}{H} ,$$

where, D represents a distance between the upright screen and the rear edge of the mirror and H represents a length of the upright screen in the upright direction of the screen.

Optionally, the angle α may further be limited to meet the following formula:

$$90 - \frac{32.7 D}{H} \leq α \leq 90 - \frac{27.3 D}{H} .$$

Further, the projection device may be configured to meet a formula:

$$\frac{1}{tan α} - \frac{1}{tan 2 α} = \frac{D}{H} .$$

In the projection device configured as above, the mirror may be arranged such that the front edge of the mirror is arranged in the vicinity of an upper edge of the upright screen.

### BRIEF DESCRIPTION OF THE ACCOMPANYING DRAWINGS

FIG. 1 is a cross-sectional side view showing a structure of a projection device according to a present invention.

FIG. 2 is a schematic diagram showing an arrangement of optical elements of a first example of the projection device according to the present invention.

FIG. 3 is a schematic diagram showing an arrangement of optical elements of a second example of the projection device according to the present invention.

FIG. 4 is a schematic diagram showing an arrangement of optical elements of a comparative example of the projection device.

FIG. 5 is a table showing the specific parameters of each projection devices in FIG. 2, FIG. 3 and FIG. 4.

### DETAILED DESCRIPTION OF THE EMBODIMENTS

Referring now to the drawings, a description will be given in detail of an illustrative embodiments in accordance with the present invention.

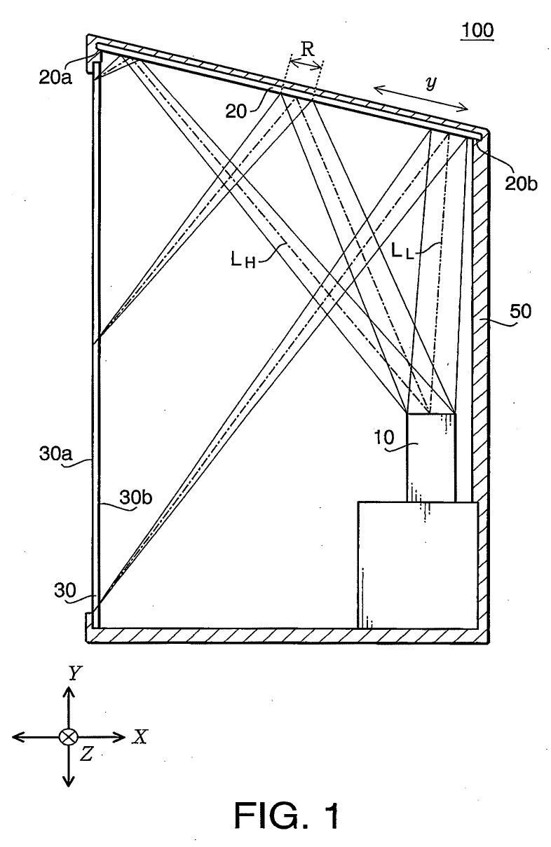

FIG. 1 is a cross-sectional side view of a projection device 100 used in a normal state, according to the present invention. Incidentally, “the normal state” referred hereinafter means a state where the projection device is placed so that a bottom surface of the projection device faces a ground surface. According to the illustrative embodiments, the projecting device is configured such that a plane of the screen is perpendicular to the ground surface. In the following description, directions will be described when the projection device is placed in the normal state. The projection device 100 is provided with a projection optical unit 10, a mirror 20 and an upright screen 30, which are incorporated in a casing 50.

As shown in FIG. 1, when the projection device 100 is in the normal state, an X direction refers to a thickness direction of the screen 30, a Y direction refers to a vertical direction, and a Z direction refers to a horizontal direction, in the following description. Additionally, lengths of the projection device in X direction, Y direction and Z direction are referred to as a depth, a height and a width, respectively.

FIG. 1 is a cross-sectional side view taken along an X-Y plane. The projection optical unit 10 is provided with a projection optical system having a light source, liquid crystal elements and a plurality of lenses (not shown), and emits light carrying an image to be projected on the upright screen 30. The light emitted from the projection optical unit 10 is divergent light and is incident on the mirror 20 fixed on a top board of the casing 50. The mirror 20 has a rectangular shape having an approximately same width as that of the screen 30. The mirror 20 is fixed on the casing 50 such that it inclines with respect to the horizontal plane by a predetermined angle on the X-Y plane. Specifically, a pair of edges 20a and 20b of the mirror 20 in the Z direction are used to fix the mirror 20 on the casing 50.

The light reflected by the mirror 20 forms an image on a rear surface 30b of the screen 30. The image is viewed in front of a front surface 30a of the screen 30.

A configuration of the projection device 100 for reducing flexure of the mirror 20 in a direction parallel to the X-Y plane and preventing a defocus of the projected image on the screen 30 will be described below.

In the oblique projection type of projection device, such as the projection device 100, an amount of the defocus is expressed by C×R². C represents a curvature C of the mirror 20 caused by the flexure of the mirror 20, and R represents a diameter, in y direction, of light beam emitted from the projection optical unit 10, reflected by the mirror 20 and converging on the screen 30, as shown in FIG. 1. The projection device 100 would provide a high image quality and less defocus if C×R² is suppressed to have a relatively small value.

The diameter R is different depending on at which portion on the screen 30 the light beam forms the predetermined image. That is, the amount of the defocus is varied depending on the position of the screen 30 the light beam forms the predetermined image.

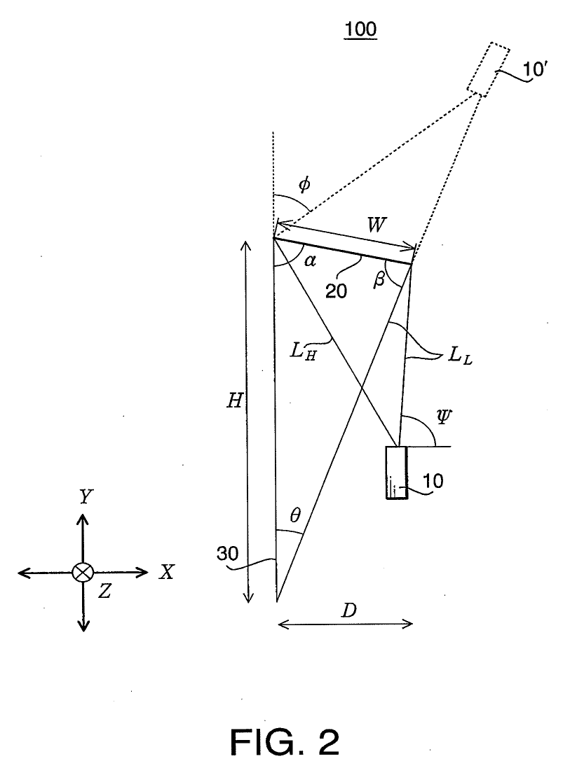

FIG. 2 is a schematic diagram showing an arrangement of optical elements of the projection device 100 on a plane parallel to the X-Y plane. In FIG. 2, a projecting optical system 10′, which corresponds to the optical unit 10, when the optical path reflected by the mirror 20 is developed, is indicated by broken lines.

The curvature C is proportional to each of the length W of the mirror 20 (which is measured in a y-direction) and the weight G of the mirror 20. As shown FIG. 2, when an angle between the mirror 20 and the screen 30 is indicated as α, the length W of the mirror 20 is proportional to 1/sin α. The weight G of the mirror 20 is proportional to the length W, that is, the weight G of the mirror 20 is also proportional to 1/sin α.

The curvature C of the mirror 20 is proportional to W×F, where W represents the length W of the mirror 20 in the y direction, and F represents the force applied to the mirror 20 in a vertical direction (Y direction). The force F in the vertical direction of the mirror 20 is G×sin α′, where an angle α′ represents an angle of the mirror 20 in the X-Y plane with respect to the Y direction (i.e. the Y-Z plane). When the projection device 100 is used in the normal state, the angle α′ is substantially equal to the angle α. Therefore, when the projection device is used in the normal state, the curvature C is proportional to the following formula (1):

1/sin α×1/sin α×sin α′=1/sin α×1/sin α×sin α=1/sin α (1)

### That is, the curvature C is proportional to 1/sin α.

The amount of the defocus due to the flexure of the mirror 20 generally has a maximum value when the light is reflected by the mirror 20 and directed to the lowest part of the screen 30. Therefore, by minimizing the diameter of the light incident on the lowest part of the screen 30, the defocus can be minimized. When the angle between the mirror 20 and the optical center of the light flux reflected by the mirror 20 and incident on the lowest part of the screen is indicated as β, the diameter R of the light on the mirror 20 is proportional to 1/sin β as shown in FIG. 2.

Since the defocus is represented by C×R², according to the above, the amount of the defocus of the prescribed position of the screen 30 is proportional to formula (2):

1/sin α×(1/sin β)² (2)

### Therefore, the projection device 100 having a less defocus at any position on the screen is provided by configuring each optical components of the projection device 100 so that a value derived from formula (2) is minimized.

Meanwhile, the projection device 100 might not be used in the normal state. For example, the projection device 100 may be used inclined with respect the Y-Z plane (i.e., inclined in a direction parallel to the X-Y plane) in FIG. 1 such that the mirror 20 is approximately parallel to the X-Z plane (i.e., a horizontal plane). In such a case, since the angle α′ is approximately 90 degrees, the formulae (1) and (2) are replaced with the following formulae (3) and (4), respectively.

1/sin α×1/sin α×sin α′=1/sin α×1/sin α×1=(1/sin α)² (3)

(1/sin α)²×(1/sin β)² (4)

Consequently, in comparison with formula (2) and (4), the amount of the defocus increases when the projection device 100 is used in the state such that the projection device 100 inclines and the mirror 20 is approximately parallel to the X-Z plane (horizontal plane).

In consideration of the above discussion, a plurality of samples of a combination of a size of the projection device 100 and an angle α (which is formed between the screen 30 and the mirror 20) providing the minimum defocus are taken and a linear approximation is performed. As a result of the approximation, the optimal angle α between the screen 30 and the mirror 20 is defined in formulae (5) and (6). In formulae (5) and (6):

$$\begin{matrix}α = 90 - \frac{38.1 D}{H} , & ( 5 ) \\ α = 90 - \frac{27.3 D}{H} & ( 6 )\end{matrix}$$

where, H represents a height of the screen 30 and D represents a depth of the casing 50 of the projection device. The formula (5) indicates an optimal angle α when the projection device is used in the normal state. The formula (6) indicates an optimal angle α when the projection device is used in the state such that the mirror 20 is substantially parallel to the X-Z plane.

Based on formulae (5) and (6), it is appreciated that, if the mirror 20 is arranged on the top side of the casing 50 of the projection device 100 such that the angle α between the screen 30 and the mirror 20 meets following formula (7), the amount of the defocus is well suppressed regardless of the usage state of the projection device 100 (i.e., regardless whether the projection device 100 is used in the normal state or inclined state).

$$90 - \frac{38.1 D}{H} \leq α \leq 90 - \frac{27.3 D}{H} \qquad ( 7 )$$

Incidentally, since the amount of the defocus increases when the projection device 100 is used in the state such that the mirror 20 is substantially parallel to the X-Z plane (horizontal plane) as described above. Therefore, the mirror 20 is preferably arranged such that a greater range defined by formula (7) is used. Accordingly, it is preferable that the angle α meets the following formula (8). It should be noted that value 32.7 is an average of values 38.1 and 27.3 indicated in formula (7).

$$90 - \frac{32.7 D}{H} \leq α \leq 90 - \frac{27.3 D}{H} \qquad ( 8 )$$

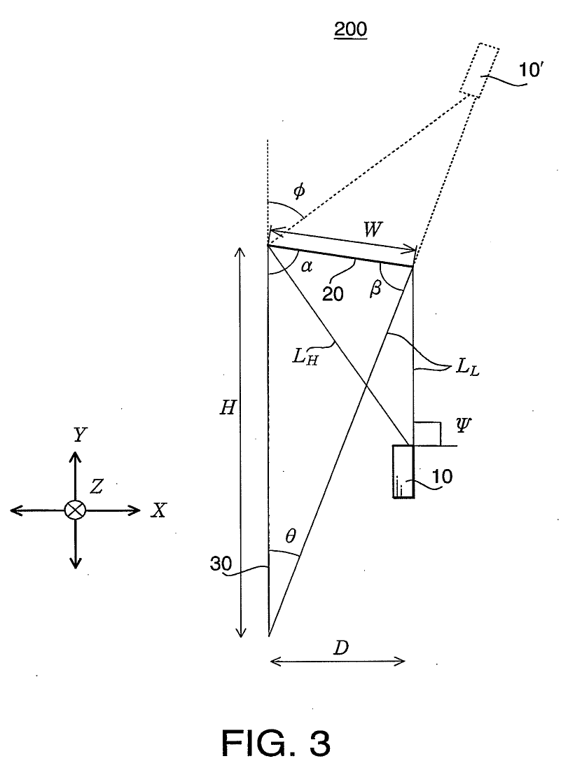

As shown in FIG. 2, in the following description, an angle, in the X-Y plane, formed between a ray L_{L} and the X-Z plane is indicated as ψ, and an angle between the ray L_{L} and the Y-Z plane (the screen 30) is indicated as θ. Incidentally, the ray L_{L} is a principal ray of light emitted from the projection optical unit 10 and is incident on the lowermost point on the screen 30, and a ray L_{H} is a principal ray of light emitted from the projection optical unit 10 and is incident on the uppermost point on the screen 30 as shown in FIG. 1. It should be appreciated that the depth D of the projection device 100 is minimized when the angle ψ is 90 degrees as shown in FIG. 3, thereby downsizing of the projection device 100 is achieved. With the above configuration (i.e. the angle ψ is 90 degrees), expansion of the image on the screen 30 in the Y direction due to astigmatism is effectively prevented.

When the angle ψ is 90 degrees, the angle α and the angle ψ has a relationship expressed by formula (9):

$$α = 90 - \frac{θ}{2} \qquad ( 9 )$$

### Using the angles α, θ and the depth D, the height H of the screen 30 is expressed by formula (10).

$$H = \frac{D}{tan θ} + \frac{D}{tan α} \qquad ( 10 )$$

The above formula (10) can be modified as follows.

$$\frac{1}{tan α} - \frac{1}{tan 2 α} = \frac{D}{H} \qquad ( 11 )$$

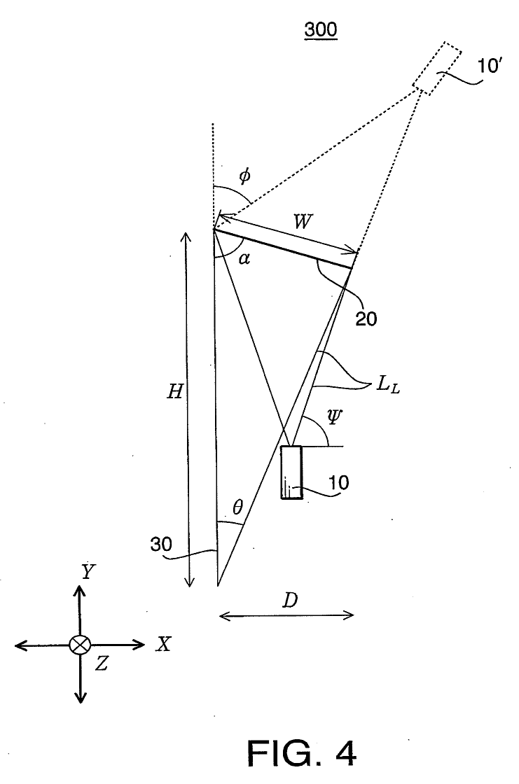

Hereinafter, concrete examples of the projection device 100 according to the above embodiment will be described. FIG. 2 is schematic diagram showing an arrangement 101 of the optical elements in a first example of the projection device. FIG. 3 is a schematic diagram showing an arrangement 200 of the optical elements in a second example of the projection device. FIG. 4 is a schematic diagram showing an arrangement 300 of the optical elements in a comparative example of the projection device. The projection device shown in FIG. 4 is an example which does not meet the requirements of the present invention as described later, and used for explaining the difference from the projection device which meets the requirements of the present invention.

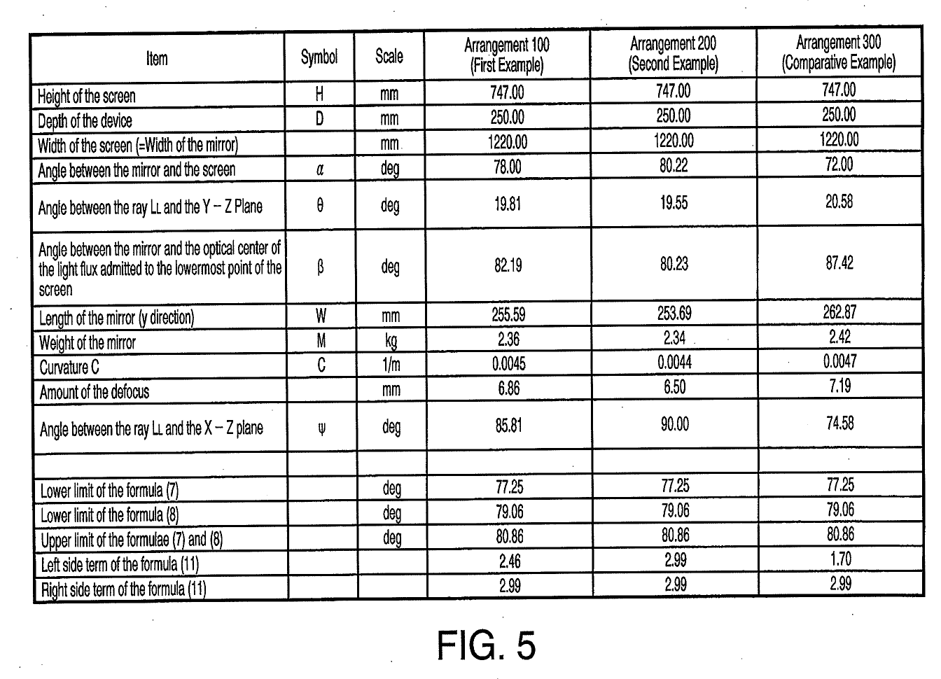

The specific parameters of each projection devices in FIG. 2, FIG. 3 and FIG. 4 are listed in a table shown in FIG. 5. It is noted that, a mirror used in each projection device has thickness of 3.0 mm, density of 2.52/cm³, and Young's module of 800.00*10⁸ N/m². Further, an f-number on the screen side is 300 in each example.

As shown in the table (FIG. 5), the first example of the projection device with the arrangement 100 is configured to meet the formula (7). In contrast, the comparative example of the projection device with the arrangement 300 does not meet any one of the formulae (7), (8) and (11). Therefore, comparing the first example of the projection device with the arrangement 100 with the comparative example of the projection device with the arrangement 300) the amount of the defocus and the curvature C of the mirror of the arrangement 101 are smaller. Similarly, the second example of the projection device with the arrangement 200 is configured to meet all of the formulae (7), (8) and (11).

Although examples of carrying out the invention have been described with reference to illustrative embodiment, the present invention is not limited to the above described embodiment.

The present disclosure relates to the subject matter contained in Japanese Patent Application No. P2006-180605, filed on Jun. 30, 2006, which is expressly incorporated herein by reference in its entirety.

What is claimed is:

1. A projection device, comprising:
an upright screen on which an image is projected;
an image projection unit configured to emit light carrying an image to be projected on the upright screen, the image projection unit being arranged behind a lower portion of the upright screen;
a mirror configured to deflect light emitted by the image projection unit toward the upright screen, the mirror being arrange behind an upper portion of the upright screen, the mirror having a front edge and a rear edge, the front edge being arranged closer to the screen than the rear edge,
wherein the mirror is arranged such that an angle α meets a formula:
$$90 - \frac{38.1 D}{H} \leq α \leq 90 - \frac{27.3 D}{H} ,$$
wherein α represents an angle formed between the upright screen and the mirror, D represents a distance between the upright screen and the rear edge of the mirror, and H represents a length of the upright screen in the upright direction of the screen.

2. The projection device according to claim 1,
wherein the angle α meets a formula:
$$90 - \frac{32.7 D}{H} \leq α \leq 90 - \frac{27.3 D}{H} .$$

3. The projection device according to claim 1, which is configured to meet a formula:
$$\frac{1}{tan α} - \frac{1}{tan 2 α} = \frac{D}{H} .$$

4. The projection device according to claim 1, wherein the mirror is arranged such that the front edge of the mirror is arranged in the vicinity of an upper end of the upright screen.

5. A projection device, comprising:
an upright screen on which an image is projected;
an image projection unit configured to emit light carrying an image to be projected on the upright screen, the image projection unit being arranged at a position corresponding to a lower portion of the upright screen;
a mirror configured to deflect light emitted by the image projection unit toward the upright screen, the mirror being arranged at a position corresponding to an upper portion of the upright screen, the mirror having a front edge and a rear edge, the front edge being arranged closer to the screen than the rear edge,
wherein the mirror is arranged such that an angle α meets a formula:
$$90 - \frac{38.1 D}{H} \leq α \leq 90 - \frac{27.3 D}{H} ,$$
wherein α represents an angle formed between the upright screen and the mirror, D represents a distance between the upright screen and the rear edge of the mirror, and H represents a length of the upright screen in the upright direction of the screen.
